(19) United States
(12) Patent Application Publication
(10) Pub. No.: US 2008/0074882 A1
(43) Pub. Date: Mar. 27, 2008

(54) Light source device structure

(76) Inventors: Jin-Sing Chou, Sinfang Township (TW); Chih-Chung Chen, Jiading Township (TW); Chi-Ping Teng, Sanchang City (TW)

Correspondence Address: Troxell Law Office Pllc, Suite 1404, 5205 Leesburg Pike, Falls Church, VA, 22041, US

(21) Appl. No.: 11/526,233

(22) Filed: Sep. 25, 2006

(51) Int. Cl. F21V 14/00; F21V 7/00

(52) U.S. Cl. 362/294; 362/257; 362/296

(57) ABSTRACT

The present invention provides an improved structure of an illuminating light source structure, including a light guide board and a light emitting member. When the light emitting member of a light source device is emitting light, the light rays irradiate the light guide board, thereby enabling the light guide board to receive the light rays, which are then uniformly reemitted and illuminate according to disposition of a lampshade, thus providing a user with soft light rays. Moreover, the illuminating light source structure can be used in a table lamp, a small night light or a fluorescent lamp fixture to achieve Illuminating lines of light and lighting effectiveness, and increases originality and practicability of the present invention.

### BACKGROUND OF THE INVENTION

(a) Field of the Invention

The present invention relates to an improved structure of an illuminating light source structure, and more particularly to an illuminating light source device structured to comprise a light guide board and a light emitting member.

(b) Description of the Prior Art

FIGS. 1 and 2 show general illuminating devices of prior art that achieve illuminating effectiveness by use of a light bulb A or a fluorescent tube B respectively. The light bulb A or the fluorescent tube B serve as a scattering non-uniform surface light source, light rays from which are unable to be unidirectionally controlled, resulting in different wavelengths and angles of light rays that easily produce visual discomfort in a user after using such light sources for a long period of time. Moreover, toxic chemical compounds contained within the light bulb A and the fluorescent tube B of prior art easily cause an environmental hazard after discarding.

Hence, the inventor of the present invention proposes to resolve and surmount existent technical difficulties to eliminate the aforementioned shortcomings of prior art.

### SUMMARY OF THE INVENTION

A primary objective of the present invention is to provide an improved structure of an illuminating light source structure, wherein a light source device is structured to comprise a light guide board and a light emitting member. The light emitting member is located at a side of the light guide board within the light source device. When the light emitting member is emitting light rays, the light rays irradiate the light guide board, thereby enabling the light guide board to receive the light rays, which are then uniformly reemitted to achieve the objective of providing illumination.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view of prior art.

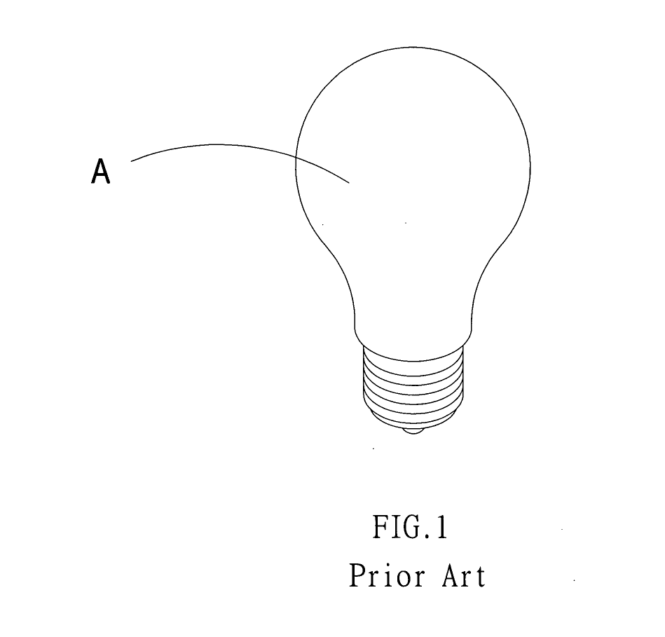

FIG. 2 shows an elevational view of another prior art.

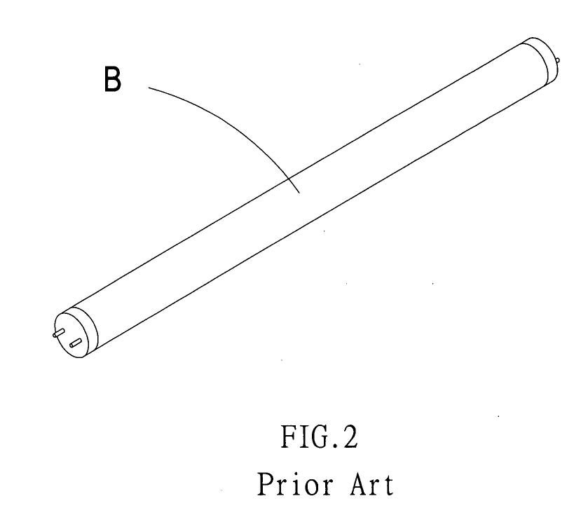

FIG. 3 shows an elevational view according to the present invention.

FIG. 4 shows an exploded elevational view according to the present invention.

FIG. 5 shows a first embodiment according to the present invention.

FIG. 6 shows a second embodiment according to the present invention.

FIG. 7 shows a third embodiment according to the present invention.

### DETAILED DESCRIPTION OF THE PREFERRED EMBODIMENTS

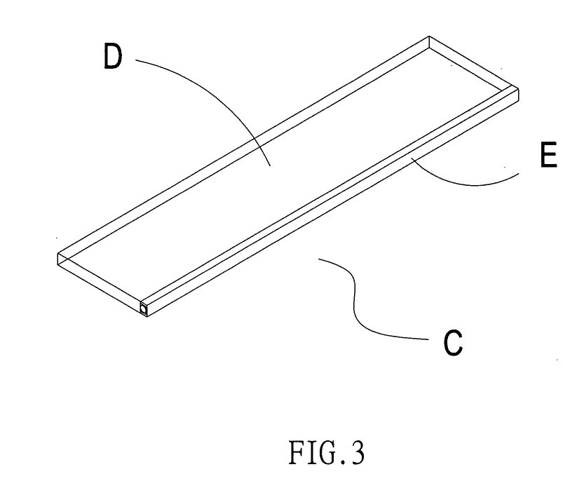

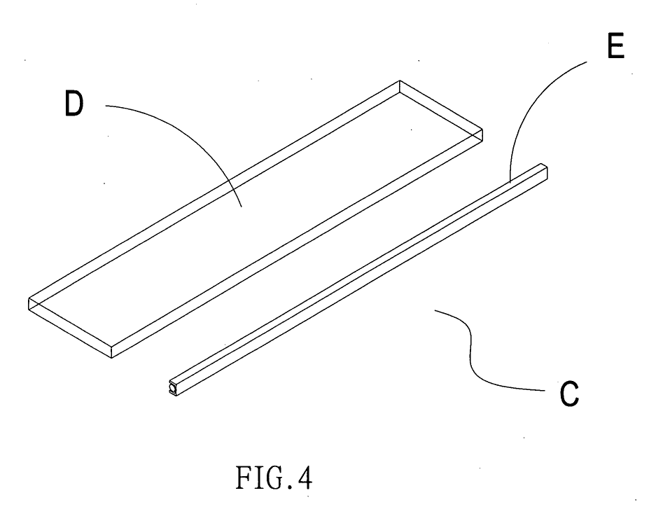

The present invention provides an improved structure of an illuminating light source structure. A light source device C is structured to comprise a light guide board D and a light emitting member E, as depicted in FIGS. 3 and 4.

The light emitting member E is located at a side of the light guide board D within the light source device C. When the light emitting member E is electrically connected and emitting light rays, the light rays irradiate the light guide board D, thereby enabling the light guide board D to receive uniform light, whereafter the light guide board D unidirectionally emits the light rays received from the light emitting member E, thus achieving required illuminating functionality.

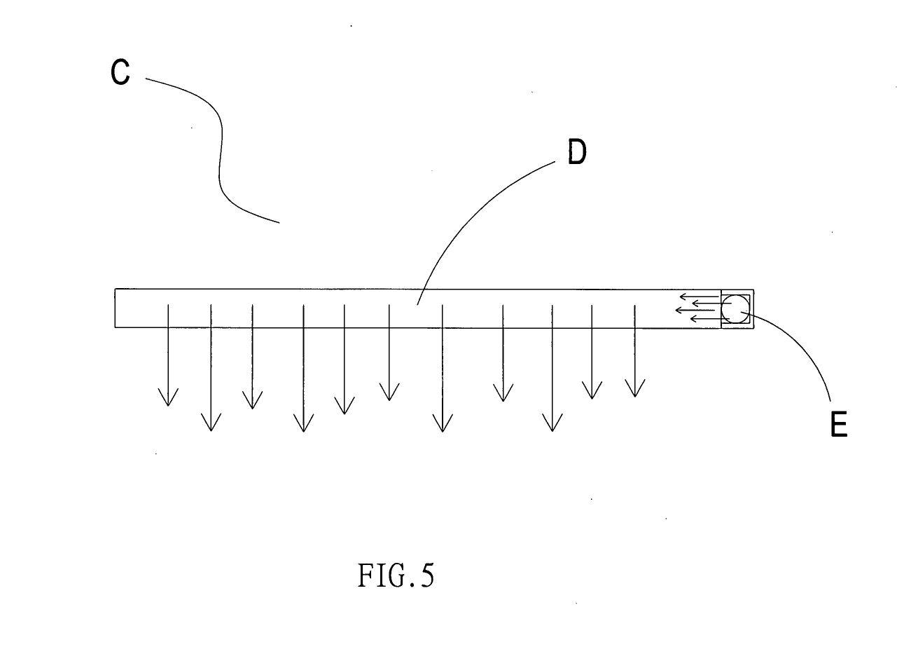

Referring to FIG. 5, which shows an embodiment of the improved structure of the illuminating light source of the present invention, wherein the light source device C comprises the light guide board D and the light emitting member E located at the side of the light guide board D. After electrically connecting the light emitting member E, light rays emitted from the light emitting member E irradiate the light guide board D, thereby enabling the light guide board D to receive uniform light, and the light rays received by the light guide board D are unidirectionally emitted outward, thus enabling a user to angularly and positionally adjust direction of the light rays according to needs.

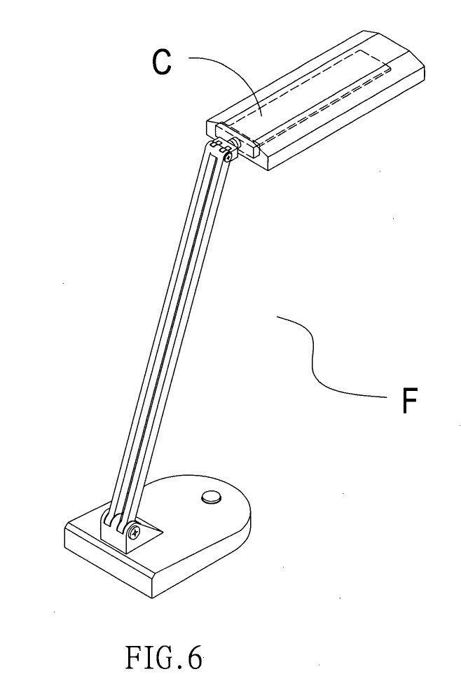

Referring to FIG. 6, which shows the light emitting device C is installed in a table lamp F, thereby achieving illuminating functionality for when a user is reading.

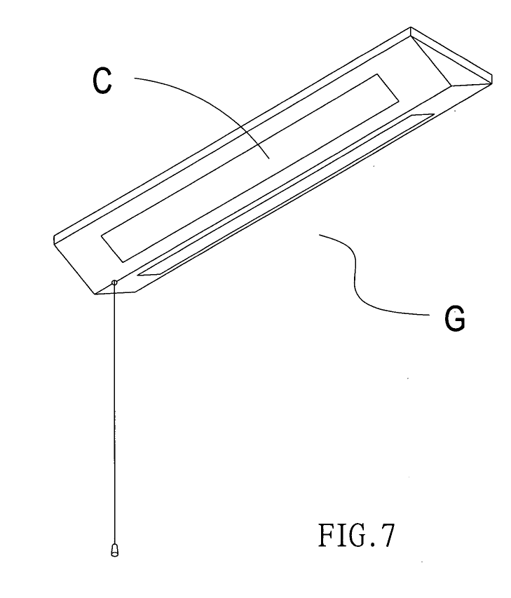

Referring to FIG. 7, which shows the light emitting device C is installed in an illuminating light fixture G, thereby achieving lighting and illumination objective.

In order to better explicitly disclose advancement and practicability of the present invention, a comparison with prior art is described hereinafter:

Shortcomings of prior art

1. Power consumption is relatively large, and wastes electricity.

2. Heat energy radiated when being used is relatively large.

3. Emitted light rays are relatively intense, which cause discomfort after a long period of use.

4. Toxic chemical compounds contained within the prior art cause environmental pollution.

### ADVANTAGES OF THE PRESENT INVENTION

1. Consumes relatively small power, and is provided with power saving functionality.

2. Heat energy radiated when being used is relatively low.

3. Emitted light rays are relatively soft, which are comfortable to a user.

4. Contains a relatively low amount of toxic chemical compounds, and thus relatively environmental friendly.

5. Not limited in size or shape, variability is large, and compatibility is high.

6. Provided with advancement and practicability.

7. Enhances commercial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A light source device structure comprising a light guide board and a light emitting member, characterized in that the light emitting member is disposed at a side of the light guide board, and the light guide board uniformly receives light when the light emitting member is emitting light, thereby achieving illuminating effectiveness.

2. The light source device structure according to claim 1, wherein the light source device is fitted in a table lamp, an indicator light, a fluorescent lamp fixture and related illuminating light fixtures.

3. The light source device structure according to claim 1, wherein the light emitting member is a light tube, a light bulb, a light-emitting diode and related members having light emitting effectiveness.

4. The light source device structure according to claim 1, wherein a heat sink device is disposed in the light source device to enable effective dissipation of heat from the light emitting member.

5. The light source device structure according to claim 1, wherein a reflector plate is disposed at a side of the light guide board, thereby increasing illuminance.

6. The light source device structure according to claim 1, wherein a light diffusion plate and a light intensifying plate are disposed at a side of the light guide board, thereby providing improved uniform mixed light to achieve softer light rays.
